(19) United States
(12) Patent Application Publication
(10) Pub. No.: US 2025/0373986 A1
(43) Pub. Date: Dec. 4, 2025

(54) Multi-magnetic Circuits Speaker

(71) Applicant: AAC Microtech (Changzhou) Co., Ltd., Changzhou City (CN)

(72) Inventors: Xin Jin, Changzhou (CN); Yun Tang, Changzhou (CN); Wei Song, Changzhou (CN)

(21) Appl. No.: 19/235,557

(22) Filed: Jun. 11, 2025

Related U.S. Application Data
(63) Continuation of application No. PCT/CN2024/097151, filed on Jun. 4, 2024.

(51) Int. Cl. H04R 9/02; H04R 9/04; H04R 9/06

(52) U.S. Cl. CPC H04R 9/025; H04R 9/045; H04R 9/046; H04R 9/063; H04R 2400/11

(57) ABSTRACT

The present disclosure provides a speaker which includes a frame, a vibration system having a diaphragm and a voice coil, a magnetic circuit system including a lower plate, a main magnetic assembly, and an auxiliary magnetic assembly. The main magnetic assembly includes a first main magnet, a main pole plate, and a second main magnet. The auxiliary magnetic assembly includes a first auxiliary magnet, an auxiliary pole plate, and a second auxiliary magnet. The magnetic circuit system further includes an upper plate. The speaker further includes a fixing ring fixed to the upper plate, including a first connecting part fixed to the upper plate, and a second connecting part extending from the first connecting part toward the lower plate for connecting to an inner periphery of the diaphragm. The disclosure optimizes the magnetic circuit system and improves drop resistance. A speaker box is also provided.

### TECHNICAL FIELD

The present application relates to the field of electro-acoustic conversions, and particularly to a multi-magnetic circuits speaker.

### BACKGROUND

With the rapid development of mobile communication technology in recent years, consumers increasingly use mobile communication devices with voice functions, such as portable phones, handheld game consoles, laptops, notebook computers, multimedia players, and other devices capable of communicating through public or private communication networks. As a playback device for voice functions, the vibration stability of multi-magnetic circuits speakers directly affects user experience and product lifespan. In related technologies, multi-magnetic circuits speakers generate strong vibrations during sound production.

Therefore, it is necessary to provide a new speaker to address the above issues.

### SUMMARY

The object of the present application is to provide a speaker with improved stability of the magnetic circuit system.

To achieve the above purpose, the present invention provides a multi-magnetic circuits speaker, comprising a frame having an accommodating space, a vibration system accommodated in the accommodating space, at least two magnetic circuit systems configured to drive the vibration system to vibrate and generate sound, each of the magnetic circuit systems comprising a yoke and a magnet disposed above the yoke, the yoke comprising a base plate and a side wall extending and bent along an edge of the base plate, a support ring fixed to the frame and surrounding the yoke; and a damping member clamped between the support ring and the side wall.

The support ring and the damping member suspend the magnetic circuit system in the accommodating space, and the magnetic circuit system is configured to counteract at least part of vibration generated by the vibration system.

In addition, the support ring is made of plastic or metal.

In addition, the damping member is made of silicone or rubber.

In addition, the magnetic circuit systems comprise a first magnetic circuit system and a second magnetic circuit system spaced apart from the first magnetic circuit system; the frame comprises a main body enclosing the accommodating space and a first connecting part connecting two sides of the main body; the first connecting part divides the accommodating space into a first accommodating space for accommodating the first magnetic circuit system and a second accommodating space for accommodating the second magnetic circuit system.

In addition, the support ring comprises a first support ring and a second support ring spaced apart from the first support ring; the first support ring surrounds the first magnetic circuit system, and the second support ring surrounds the second magnetic circuit system.

In addition, the support ring further comprises a second connecting part connecting the first support ring and the second support ring, and the second connecting part is fixed to the first connecting part.

In addition, each of the first support ring and the second support ring comprises an annular main body and a joint part extending from the annular main body and fixed to the damping member, and the annular main body is fixed to the frame.

In addition, the multi-magnetic circuits speaker further comprises an electrical connector fixed to the first connecting part, wherein the electrical connector comprises a first electrical connector and a second electrical connector adjacent to the first electrical connector; the vibration system comprises a first voice coil and a second voice coil spaced apart from the first voice coil; the first voice coil partially extends into the first magnetic circuit system, and the second voice coil partially extends into the second magnetic circuit system; and the first voice coil and the second voice coil are electrically connected to an external circuit through the first electrical connector and the second electrical connector.

In addition, the electrical connector comprises: a first fixing part electrically connected to the first voice coil; a second fixing part electrically connected to the second voice coil; a third fixing part electrically connected to the external circuit; and a third connecting part connecting the first fixing part, the second fixing part, and the third fixing part.

The advantageous effects of the present application are as follows. The present application provides a multi-magnetic circuits speaker, comprising a support ring fixed to the frame and surrounding the yoke, and a damping member clamped between the yoke and the support ring. The support ring and the damping member suspend the magnetic circuit system in the accommodating space. Compared with related technologies, the present application combines multiple magnetic circuit systems with the support ring and damping member fixed to the frame, thereby improving the installation stability of the multiple magnetic circuit systems and achieving a vibration-damping effect for the multi-magnetic circuits speaker.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a multi-magnetic circuits speaker as described in Embodiment 1 of the present application.

FIG. 2 is an isometric view of a multi-magnetic circuits speaker as described in Embodiment 2 of the present application.

FIG. 3 is an exploded view of the multi-magnetic circuits speaker shown in FIG. 1.

FIG. 4 is an exploded view of the multi-magnetic circuits speaker shown in FIG. 2.

FIG. 5 is a cross-sectional view of the multi-magnetic circuits speaker shown in FIG. 1, taken along line A-A.

FIG. 6 is a cross-sectional view of the multi-magnetic circuits speaker shown in FIG. 1, taken along line B-B.

FIG. 7 is an isometric view of the multi-magnetic circuits speaker shown in FIG. 1 with a diaphragm thereof removed.

FIG. 8 is a cross-sectional view of the multi-magnetic circuits speaker shown in FIG. 2, taken along line C-C.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

### Embodiment 1

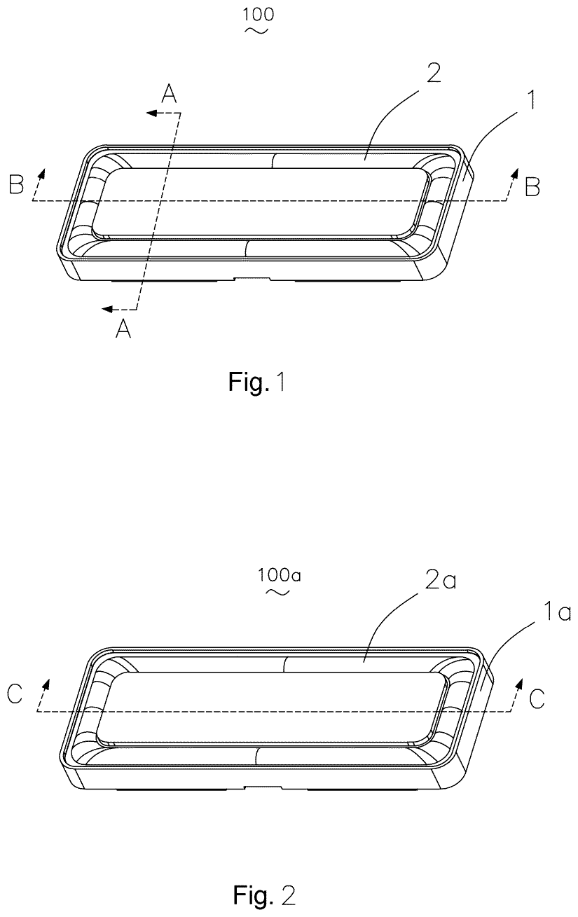

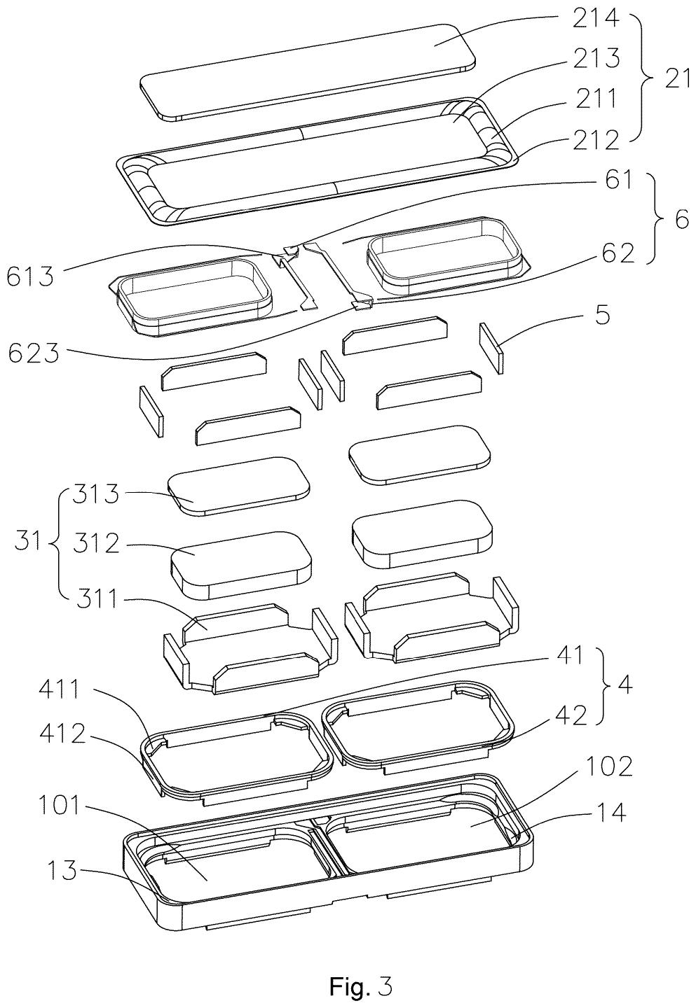

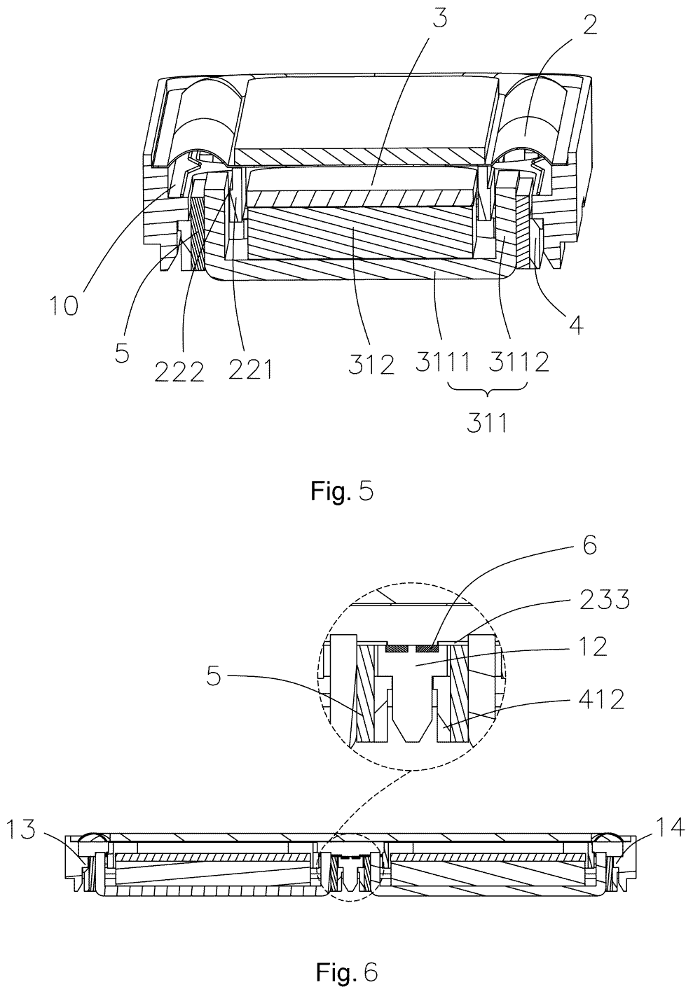

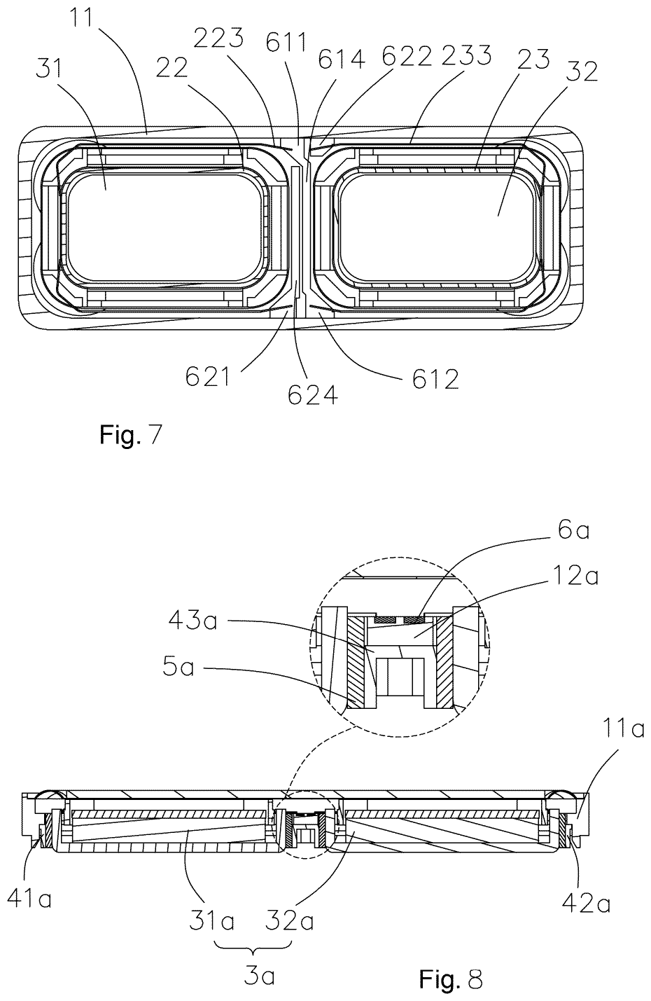

Referring to FIGS. 1, 3, and 5-7, the present application provides a multi-magnetic circuits speaker 100, comprising a frame 1 having an accommodating space 10, a vibration system 2 accommodated in the accommodating space 10, a magnetic circuit system 3 configured to drive the vibration system 2 to vibrate and generate sound, a support ring 4 fixed to the frame 1, a damping member 5 clamped between the magnetic circuit system 3 and the support ring 4, and an electrical connector 6 fixed to the frame 1.

The magnetic circuit system 3 includes a first magnetic circuit system 31 and a second magnetic circuit system 32 spaced apart from the first magnetic circuit system 31. In other embodiments, the number of magnetic circuit systems 3 may be three or more.

The frame 1 comprises a main body 11 enclosing the accommodating space 10 and a first connecting part 12 connecting two sides of the main body 11. The first connecting part 12 divides the accommodating space 10 into a first accommodating space 101 for accommodating the first magnetic circuit system 31 and a second accommodating space 102 for accommodating the second magnetic circuit system 32. The electrical connector 6 is fixed to the first connecting part 12.

The frame 1 further includes a first protruding part 13 extending into the first accommodating space 101 and a second protruding part 14 extending into the second accommodating space 102.

The vibration system 2 comprises a diaphragm 21, a first voice coil 22 configured to vibrate the diaphragm 21 to generate sound, and a second voice coil 23 spaced apart from the first voice coil 22. The diaphragm 21 includes a suspension part 211, a fixing part 212 connected to one end of the suspension part 211, and a planar part 213 connected to the other end of the suspension part 211. The fixing part 212 is fixed to the frame 1, and a strengthened part 214 is attached to a side of the planar part 213 away from the voice coil 22.

The first voice coil 22 partially extends into the first magnetic circuit system 31, and the second voice coil 23 partially extends into the second magnetic circuit system 32. The first voice coil 22 includes an inner loop 221 and an outer loop 222 extending circumferentially around the inner loop 221. Similarly, the second voice coil 23 has the same structure as the first voice coil 22, and thus its description is omitted.

The first voice coil 22 includes a first leading wire 223, and the second voice coil 23 includes a second leading wire 233. The first leading wire 223 extends along the top of the first protruding part 13 to the first connecting part 12 and is electrically connected to the electrical connector 6. The second leading wire 233 extends along the top of the second protruding part 14 to the first connecting part 12 and is electrically connected to the electrical connector 6. The first protruding part 13 and the second protruding part 14 are configured to support the first leading wire 223 and the second leading wire 233. In other embodiments, the number of voice coils 22 may be three or more.

The first magnetic circuit system 31 comprises a yoke 311, a magnet 312 disposed above the yoke 311, and a pole plate 313 disposed above the magnet 312. The yoke 311 includes a base plate 3111 and a side wall 3112 extending and bent along an edge of the base plate 3111. The first voice coil 22 is suspended in a magnetic gap between the magnet 312 and the side wall 3112.

The support ring 4 surrounds the yoke 311, and the damping member 5 is clamped between the support ring 4 and the side wall 3112. The second magnetic circuit system 32 has the same structure as the first magnetic circuit system 31, and thus its description is omitted. The support ring 4 and the damping member 5 suspend the magnetic circuit system 3 in the accommodating space 10, and the magnetic circuit system 3 is configured to counteract at least part of the vibration generated by the vibration system 2.

The support ring 4 includes a first support ring 41 and a second support ring 42 spaced apart from the first support ring 41. The first support ring 41 surrounds the first magnetic circuit system 31, and the second support ring 42 surrounds the second magnetic circuit system 32.

Both the first support ring 41 and the second support ring 42 include an annular main body 411 and a joint part 412 extending from the annular main body 411 and fixed to the damping member 5. The annular main body 411 is fixed to the frame 1. The first protruding part 13 is fixed to the first support ring 41, and the second protruding part 14 is fixed to the second support ring 42. The first support ring 41 and the second support ring 42 are separately formed as split structures.

The material of the support ring 4 is plastic, and the support ring 4 is adhesively connected to the frame 1. In other embodiments, the material of the support ring 4 may be metal. The material of the damping member 5 is silicone, and the damping member 5 is adhesively connected to the support ring 4. In other embodiments, the material of the damping member 5 may be rubber.

The first support ring 41 and the damping member 5 suspend the first magnetic circuit system 31 in the first accommodating space 101, and the second support ring 42 and the damping member 5 suspend the second magnetic circuit system 32 in the second accommodating space 102. The vibration of the magnetic circuit system 3 counteracts at least part of the vibration generated by the vibration system 2. The present application achieves a vibration-damping effect for the multi-magnetic circuits speaker by individually fixing each magnetic circuit system to the frame 1 through the support ring 4 and the damping member 5. Additionally, the support ring 4 and the damping member 5 are jointly fixed to the frame 1, enabling the magnetic circuit system 3 to be more conveniently and stably fixed to the frame 1.

The electrical connector 6 includes a first electrical connector 61 and a second electrical connector 62 adjacent to the first electrical connector 61. The first electrical connector 61 includes a first fixing part 611 electrically connected to the first voice coil 22, a second fixing part 612 electrically connected to the second voice coil 23, a third fixing part 613 electrically connected to an external circuit, and a third connecting part 614 connecting the first fixing part 611, the second fixing part 612, and the third fixing part 613.

The second electrical connector 62 includes a first fixing part 621 electrically connected to the first voice coil 22, a second fixing part 622 electrically connected to the second voice coil 23, a third fixing part 623 electrically connected to the external circuit, and a third connecting part 624 connecting the first fixing part 621, the second fixing part 622, and the third fixing part 623.

The first leading wire 223 of the first voice coil 22 is electrically connected to the external circuit through the first fixing part 611 of the first electrical connector 61 and the first fixing part 621 of the second electrical connector 62. The second leading wire 233 of the second voice coil 23 is electrically connected to the external circuit through the second fixing part 612 of the first electrical connector 61 and the second fixing part 622 of the second electrical connector 62.

### Embodiment 2

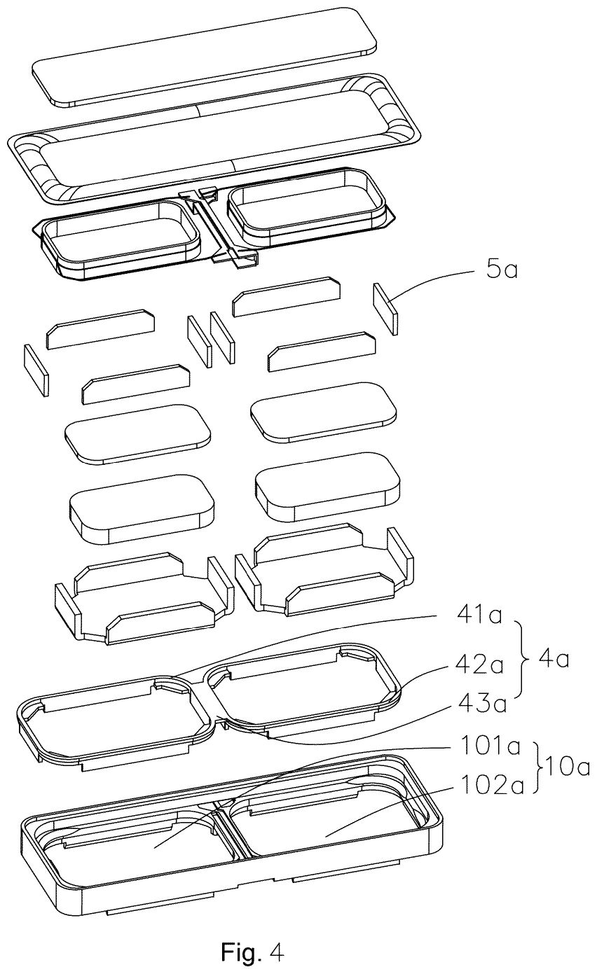

Referring to FIGS. 2, 4, and 8, the multi-magnetic circuits speaker 100a of Embodiment 2 is substantially the same as the multi-magnetic circuits speaker 100 of Embodiment 1, and thus the identical parts are not repeated here. The difference between the multi-magnetic circuits speaker of Embodiment 2 and that of Embodiment 1 lies in the structure of the support ring and the frame. The structure of the support ring and the frame in Embodiment 2 is described as follows.

The frame 1a includes a main body 11a enclosing the accommodating space and a first connecting part 12a connecting two sides of the main body 11a. The first connecting part 12a divides the accommodating space 10a into a first accommodating space 101a for accommodating the first magnetic circuit system 31a and a second accommodating space 102a for accommodating the second magnetic circuit system 32a. The electrical connector 6a is fixed to the first connecting part 12a.

The support ring 4a includes a first support ring 41a surrounding the first magnetic circuit system 31a, a second support ring 42a surrounding the second magnetic circuit system 32a; and a second connecting part 43a connecting the first support ring 41a and the second support ring 42a.

The second connecting part 43a is fixed to the first connecting part 12a. The first support ring 41a, the second support ring 42a, and the second connecting part 43a are integrally formed as a one-piece structure.

The support ring 4a is fixed to the frame 1a and surrounds the magnetic circuit system 3a. The support ring 4a and the damping member 5a jointly suspend the first magnetic circuit system 31a and the second magnetic circuit system 32a in the accommodating space 10a. The vibration of the magnetic circuit system 3a counteracts at least part of the vibration generated by the vibration system 2a. The present application combines the first magnetic circuit system 31a and the second magnetic circuit system 32a with the support ring 4a and the damping member 5a to achieve a vibration-damping effect for the multi-magnetic circuits speaker. Additionally, the support ring 4a and the damping member 5a are jointly fixed to the frame 1a, enabling the magnetic circuit system 3a to be more conveniently and stably fixed to the frame 1a.

Compared with related technologies, the present application provides a multi-magnetic circuits speaker, comprising a frame having an accommodating space, a vibration system accommodated in the accommodating space, at least two magnetic circuit systems configured to drive the vibration system to vibrate and generate sound, each of the magnetic circuit systems comprising a yoke and a magnet disposed above the yoke, the yoke comprising a base plate and a side wall extending and bent along an edge of the base plate, a support ring fixed to the frame and surrounding the yoke, and a damping member clamped between the support ring and the side wall. The support ring and the damping member suspend the magnetic circuit system in the accommodating space, and the magnetic circuit system is configured to counteract at least part of the vibration generated by the vibration system.

In the present application, the support ring and the damping member suspend the magnetic circuit system in the accommodating space. By combining multiple magnetic circuit systems with the support ring and the damping member fixed to the frame, the installation stability of the magnetic circuit systems is improved, and the vibration-damping effect of the multi-magnetic circuits speaker is achieved.

The foregoing is merely illustrative of embodiments of the present invention, and it should be noted that modifications may be made to those skilled in the art without departing from the spirit of the invention but are intended to be within the scope of the inventio

What is claimed is:

1. A multi-magnetic circuits speaker, comprising:
a frame having an accommodating space;
a vibration system accommodated in the accommodating space;
at least two magnetic circuit systems configured to drive the vibration system to vibrate and generate sound, each of the magnetic circuit systems comprising a yoke and a magnet disposed above the yoke, the yoke comprising a base plate and a side wall extending and bent along an edge of the base plate;
a support ring fixed to the frame and surrounding the yoke; and
a damping member clamped between the support ring and the side wall;
wherein the support ring and the damping member suspend the magnetic circuit system in the accommodating space, and the magnetic circuit system is configured to counteract at least part of vibration generated by the vibration system.

2. The multi-magnetic circuits speaker as described in claim 1, wherein the support ring is made of plastic or metal.

3. The multi-magnetic circuits speaker as described in claim 1, wherein the damping member is made of silicone or rubber.

4. The multi-magnetic circuits speaker as described in claim 1, wherein the magnetic circuit systems comprise a first magnetic circuit system and a second magnetic circuit system spaced apart from the first magnetic circuit system; the frame comprises a main body enclosing the accommodating space and a first connecting part connecting two sides of the main body; the first connecting part divides the accommodating space into a first accommodating space for accommodating the first magnetic circuit system and a second accommodating space for accommodating the second magnetic circuit system.

5. The multi-magnetic circuits speaker as described in claim 4, wherein the support ring comprises a first support ring and a second support ring spaced apart from the first support ring; the first support ring surrounds the first magnetic circuit system, and the second support ring surrounds the second magnetic circuit system.

6. The multi-magnetic circuits speaker as described in claim 5, wherein the support ring further comprises a second connecting part connecting the first support ring and the second support ring, and the second connecting part is fixed to the first connecting part.

7. The multi-magnetic circuits speaker as described in claim 5, wherein each of the first support ring and the second support ring comprises an annular main body and a joint part extending from the annular main body and fixed to the damping member, and the annular main body is fixed to the frame.

8. The multi-magnetic circuits speaker as described in claim 4, further comprising an electrical connector fixed to the first connecting part, wherein the electrical connector comprises a first electrical connector and a second electrical connector adjacent to the first electrical connector; the vibration system comprises a first voice coil and a second voice coil spaced apart from the first voice coil; the first voice coil partially extends into the first magnetic circuit system, and the second voice coil partially extends into the second magnetic circuit system; and the first voice coil and the second voice coil are electrically connected to an external circuit through the first electrical connector and the second electrical connector.

9. The multi-magnetic circuits speaker as described in claim 8, wherein the electrical connector comprises: a first fixing part electrically connected to the first voice coil; a second fixing part electrically connected to the second voice coil; a third fixing part electrically connected to the external circuit; and a third connecting part connecting the first fixing part, the second fixing part, and the third fixing part.

10. The multi-magnetic circuits speaker as described in claim 5, wherein the frame further includes a first protruding part extending into the first accommodating space, and a second protruding part extending into the second accommodating space; the first protruding part engages with the first supporting ring, and the second protruding part engages with the second supporting ring.
